(19) United States
(12) Patent Application Publication
(10) Pub. No.: US 2007/0247639 A1
(43) Pub. Date: Oct. 25, 2007

(54) Device and Method for Optical Precision Measurement

(75) Inventors: Willem D.Van Amstel, Geldrop (NL); Niels A. J. Van Der Beek, Eindhoven (NL); Stefan M.B. Baumer, Valkenswaard (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,861

(22) PCT Filed: May 6, 2005
(86) PCT No.: PCT/IB05/51487

§ 371 Date: Nov. 9, 2006

Related U.S. Application Data
(60) Provisional application No. 60/569,565, filed on May 10, 2004.

(51) Int. Cl. G01B 11/02

(52) U.S. Cl. 356/601; 356/625

(57) ABSTRACT

A device and method of optical precision measurement of a component. In the method, an optical probe is provided at a location relative to the component (120) and a source beam directed to the component (122). Deviation is detected (124) and stored in a component characteristic dataset (126). The optical source is moved to other locations relative to the component (128) and additional data acquired (130). The device includes an optical probe (24) providing a source beam (38), a probe stage (22) operable to rotate the optical probe (24) about a θ-axis, a component stage (26) operable to rotate the component (28) about a φ-axis, and a position sensitive detector. The probe (22) directs the source beam (38) to the component (28), the source beam (38) generates a resultant beam from the component (28), and the position sensitive detector detects the resultant beam.

This invention relates generally to precision measurement, and more specifically to optical precision measurement.

Increased precision in manufactured components requires increased precision in measurement. The tools and molds used to make the components must be precisely made to produce a precision component. The finished components must be measured to assure they meet precise tolerances. Examples of industries requiring precision measurement include the optics, ophthalmic, and high precision machining industries. Precision measurement is used for measuring lenses, spectacle lenses, contact lenses, reflectors, mirrors, lens systems, and precision molds used in making such items. Precision measurement is also used to monitor processes such as injection molding, replication, and numerically controlled polishing.

Precision measurement of optical components requires measurement of the optical component topography, i.e., the form and the shape of the component. Optical components in which light is transmitted through the component, such as lenses, also require measurement of wave front quality. Presently, precision measurement of optical components is performed by three methods: stylus probe contact sensing, interferometry, or wave front sensing. Each of these methods presents its own limitations and problems.

Stylus probe contact sensing involves placing a stylus probe in contact with points on the surface under test and mapping the shape of the surface. Stylus probe contact sensing is limited to measuring surface topography and cannot measure wave front quality. Because the stylus probe makes physical contact with the surface under test, stylus probe contact sensing cannot be used on delicate or resilient surfaces. During testing, there is a tradeoff between speed of measurement and the stylus probe contact force required to obtain accurate measurements. In addition, assembling the point data into a three dimensional topography is complicated and time consuming.

Interferometry involves measurements using the interference between two beams of light and can use phase stepping methods with phase shifting. Interferometry is useful for spherical or nearly spherical surfaces and wave fronts, but not for steep aspheric, toric, or free form surfaces and wave fronts. Non-spherical surfaces and wave fronts require generation of a reference, such as a computer generated hologram, inside the interferometer. Computer generated holograms are specific to a particular design and so are expensive and require production lead time. Therefore, computer generated holograms are only used for specialty or large series applications. Fundamental problems with interferometry include limited lateral resolution from charge-coupled device (CCD) sensors typically employed, limited height or asphericity range, and limited local slope and local power range. Another limitation of interferometry is the physical testing arrangement. A single testing arrangement cannot be used for both reflection and transmission testing. Furthermore, a single testing arrangement cannot be used for small components, such as mobile phone camera lenses, and for large components, such as spectacle lenses.

Wave front sensing (WFS), such as testing with a Shack Hartmann sensor, involves slope sensing across an image from an array of apertures or lenslets. The lateral resolution is limited by the number and size of the apertures or lenslets. Because of the trade off between lateral resolution and slope range resolution, the local power range is limited.

It would be desirable to have a device and system for optical precision measurement that overcomes the above disadvantages.

One aspect of the present invention provides a method of optical precision measurement of a component. An optical probe is provided at a first location relative to the component and a source beam directed from the optical probe to a pixel on the component. Deviation of a resultant beam from the pixel is detected and stored in a component characteristic dataset. The optical source is moved to other locations relative to the component. The directing, detecting, and storing are repeated for the other locations.

Another aspect of the present invention provides a system for optical precision measurement of a component, including an optical probe at a first location relative to the component, means for directing a source beam from the optical probe to a pixel on the component, means for detecting deviation of a resultant beam from the pixel, means for storing the deviation in a component characteristic dataset, means for moving the optical source to other locations relative to the component, and means for repeating the directing, the detecting, and the storing for the other locations.

Another aspect of the present invention provides a device for optically measuring a component, including an optical probe providing a source beam, a probe stage being operable to rotate the optical probe about a θ-axis, a component stage being operable to rotate the component about a φ-axis, and a position sensitive detector. The probe stage directs the source beam to the component, the source beam generates a resultant beam from the component, and the position sensitive detector detects the resultant beam.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

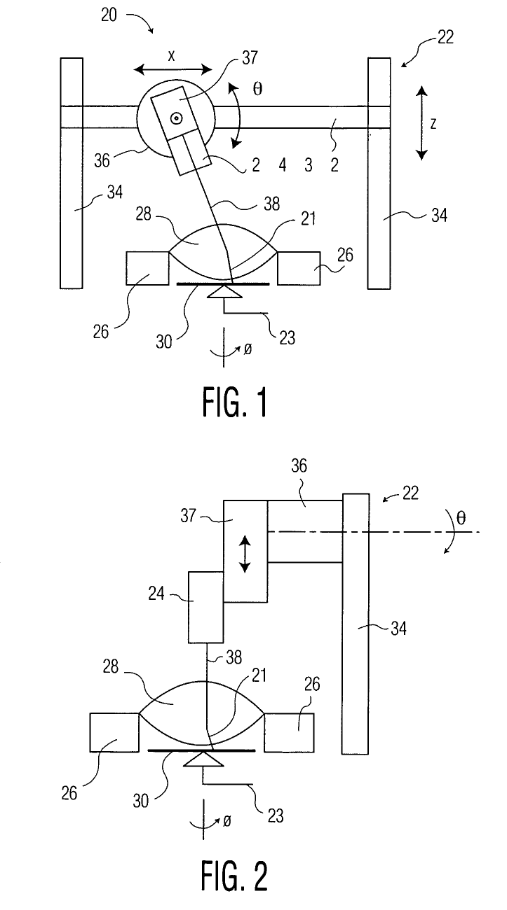

FIGS. 1 & 2 are front and side views, respectively, of an optical precision measurement device made in accordance with the present invention;

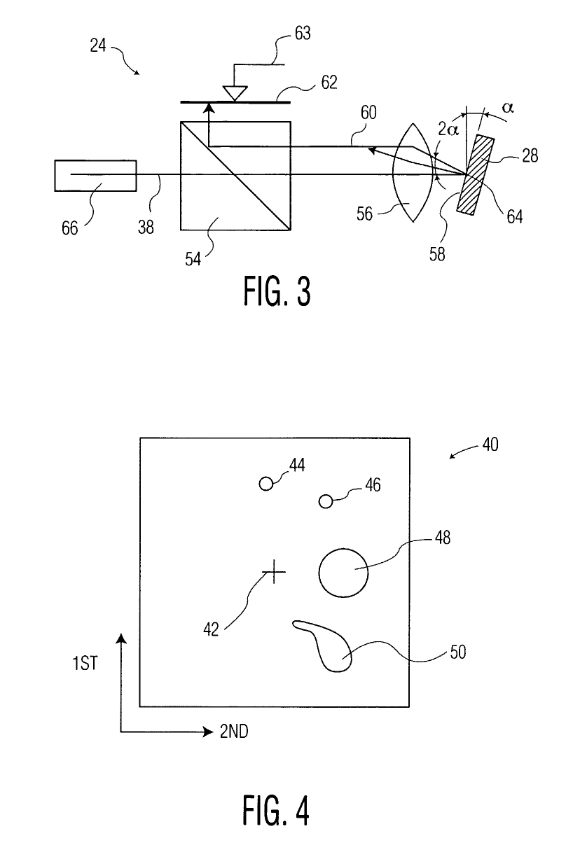

FIG. 3 is a schematic diagram of an optical probe for an optical precision measurement device made in accordance with the present invention;

FIG. 4 is a schematic diagram of a position sensitive device for an optical precision measurement device made in accordance with the present invention;

FIGS. 5 & 6 are front and side views, respectively, of an alternative embodiment of an optical precision measurement device made in accordance with the present invention;

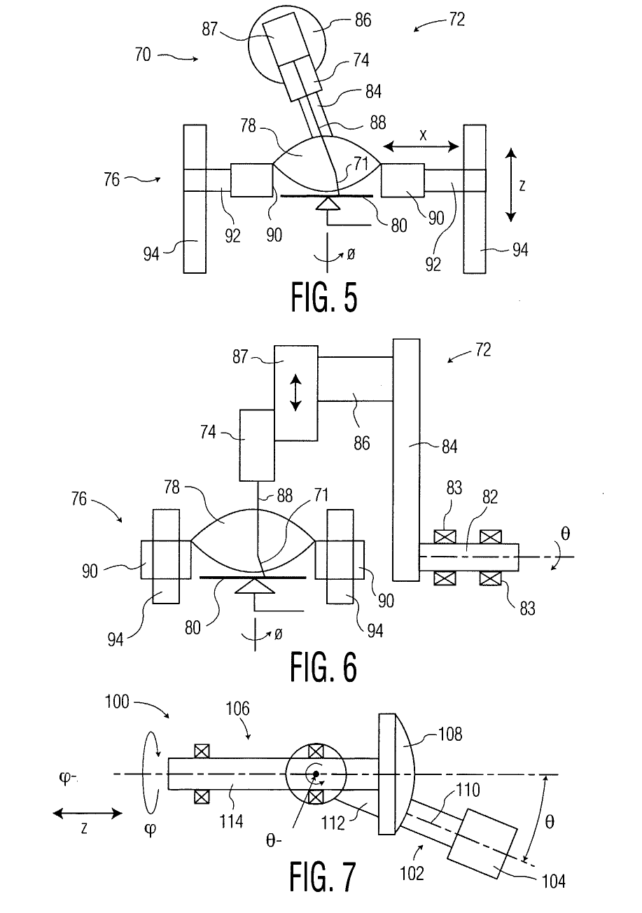

FIG. 7 is a front view of another alternative embodiment of an optical precision measurement device made in accordance with the present invention;

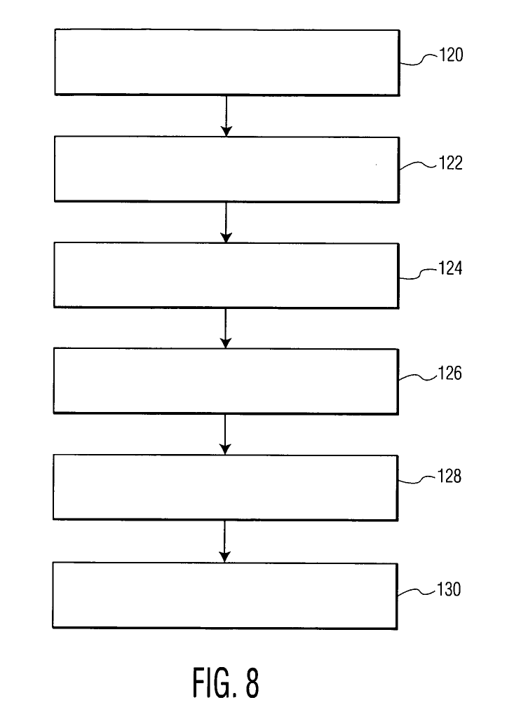

FIG. 8 is a flow diagram for a method of optical precision measurement in accordance with the present invention.

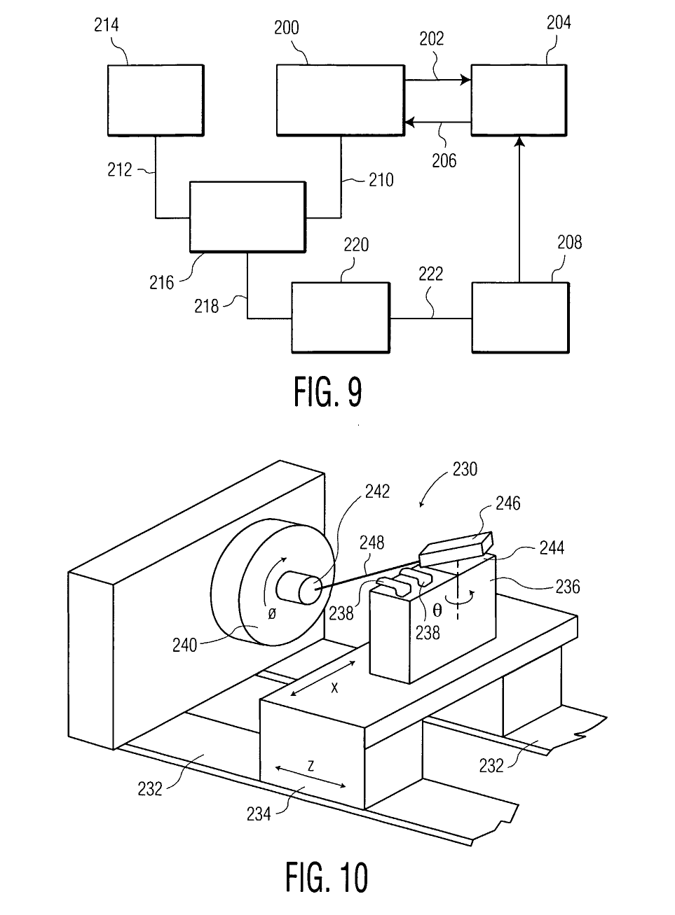

FIG. 9 is a block diagram for machine control incorporating a method of optical precision measurement in accordance with the present invention.

FIG. 10 is a perspective view of a lathe including an optical precision measurement device made in accordance with the present invention.

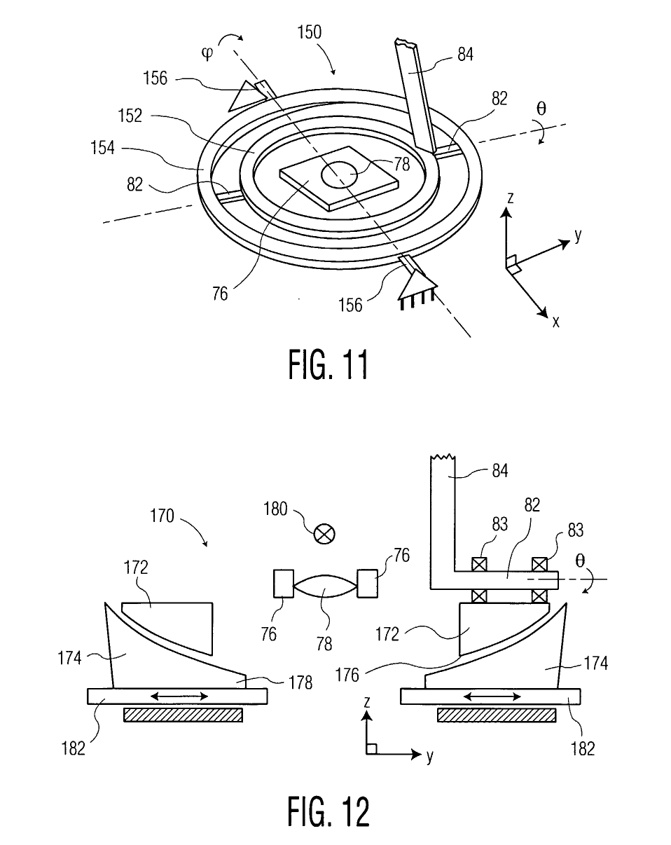

FIGS. 11 & 12 are a perspective and cross section view, respectively, of alternative embodiments of supports for a probe stage of an optical precision measurement device made in accordance with the present invention.

FIGS. 1 & 2, in which like elements share like reference numbers, are front and side views, respectively, of an optical precision measurement device made in accordance with the present invention. Optical measuring device 20 includes a probe stage 22 supporting optical probe 24 and a component stage 26 supporting component 28. In one embodiment, the optical measuring device 20 includes a transmission position sensitive device (PSD) 30 mounted behind the component 28 from the optical probe 24. The probe stage 22 and component stage 26 control movement of the optical probe 24 with respect to the component 28. In the reflection mode, the optical probe 24 emits a source beam 38 incident on the component 28 at a pixel. The source beam 38 is reflected and/or diffracted by the component 28, which generates a reflected beam (not shown) back to the optical probe 24 for detection and analysis. In the transmission mode, the source beam 38 incident on the component 28 at a pixel is transmitted, refracted, and/or diffracted by the component 28, which generates a transmitted beam 21 detected at the transmission position sensitive device 30 for analysis. Testing in the reflection mode and the transmission mode can be performed individually, concurrently, or simultaneously, as desired. Deviation is detected between the source beam and the resultant beam from the pixel: the resultant beam is the reflected beam in the reflection mode and the transmitted beam in the transmission mode.

The optical probe 24 uses a narrow beam laser to generate the source beam, and a reflection position sensitive device (PSD) to detect the reflected beam in the reflection mode. The optical probe 24 and its operation are described in relation to FIGS. 3 & 4 below.

Referring to FIGS. 1 & 2, the component 28 under test is any component for which topography and/or transmission measurements are desired. For example, the component 28 can be an optical component, such as a lens, mirror, or other optical component, which is spherical, nearly spherical, or of a more complex design, such as toric, steep aspheric, vari-focal, or free form. Typical lenses tested as components are any devices intended for wave front or ray field modification, such as CD players lenses, spectacles, contact lenses, camera lenses, photo-lithography lenses, Schmidt correctors, diffractive optical elements, and holograms. Lenses can be tested for topography and optical characteristics. In another example, the component 28 for which the topography is to be measured, such as a lens making tool or lens insert used in manufacturing contact lenses, is made of an opaque material, such as a metal or a semiconductor. The surface of the component 28 reflects the source beam back to the optical probe for topography measurements, so the surface needs to be glossy, i.e., more specular than diffuse. The surface can be naturally glossy, such as commonly occurs in optics materials or metal, or can be treated to make it glossy, such as by metallizing the surface.

The probe stage 22 and the component stage 26 control the relative motion of the optical probe 24 and the component 28. In one embodiment, the probe stage 22 includes an x-stage 32, a z-stage 34, and a θ-stage 36. The x-stage 32 and the z-stage 34 provide linear motion in the x and z directions, respectively. The θ-stage 36 provides rotation of the optical probe 24 about the θ-axis, which is orthogonal to the x-z plane. The component stage 26 can rotate the component 28 about the φ-axis, which is parallel to the x-z plane and perpendicular to the x-axis when projected onto the x-z plane. The component stage 26 can also hold the component 28 stationary without rotation. In one embodiment, the probe stage 22 further includes an optional radial stage 37 providing movement of the optical probe 24 radially to the θ-axis. The radial stage 37 allows focusing of the source beam 38 on the component 28. In an alternative embodiment, the radial stage 37 is omitted.

The probe stage 22 supports the optical probe 24 at a distance of nanometers to meters from the component 28, depending on the particular component 28 under test. As an example, the probe stage 22 supports the optical probe 24 at a distance of about 20 mm from the component 28 when the component 28 is a contact lens or a contact lens insert. In an alternative embodiment, the probe stage 22 supports the optical probe 24 at a large distance from the component 28 to permit working of the component 28 with a tool such as a lathe, grinder, or polisher. The probe stage 22 and the component stage 26 include bearings, motors, and position encoders as known to those skilled in the art. The repeatability of stage movement and precision of measurement is typically sufficient to direct the source beam to a pixel or fraction of a pixel with accurate control of slope and tilt as desired for a particular application. Thus, the optical measuring device 20 can measure shapes in the nanometer range without the probe stage 22 and the component stage 26 controlling motion to the nanometer.

Those skilled in the art will appreciate that numerous combinations of motion for the θ-stage 36 and the component stage 26 can be used to produce the desired relative motion between the optical probe 24 and the component 28. In an alternative embodiment, the θ-stage 36 supporting the optical probe 24 is located in a fixed x-z position and the component stage 26 supporting the component 28 provides motion in the x and z directions. In another alternative embodiment, both the θ-stage 36 and the component stage 26 provide motion in the x and z directions. In yet another alternative embodiment, an additional degree of freedom is provided by moving either or both the optical probe 24 and the component 28 in the y direction orthogonal to the x-z plane.

The transmission position sensitive device (PSD) 30 is a light sensitive detector capable of detecting the transmitted beam and generating a transmitted data signal 23 for capture in a data acquisition system and stored in a component characteristic dataset for analysis. The transmission PSD 30 indicates the deviation of the transmitted beam from the path of the source beam 38. Suitable devices include, but are not limited to, analog devices, such as analog lateral-effect photodiodes, and digital devices, such as charge-coupled device (CCD) sensors or complementary metal oxide semiconductor (CMOS) sensors. Typical devices are described in U.S. Pat. No. 5,136,192 to Kooijman, entitled High Speed Measuring Device Utilizing Logarithmic Conversion, and U.S. Pat. No. 5,252,864 to Kooijman, entitled Normalization Circuit For A Measuring Device, both incorporated herein by reference. In one embodiment, the transmission PSD 30 measures the location of the transmitted beam in two directions, so that the deviation of the source beam 38 by the component 28 can be calculated in two directions. In another embodiment, the transmission PSD 30 includes multiple light sensing elements spaced closely enough to allow determination of shape, directly or by interpolation.

The particular performance requirements of the transmission PSD 30 depend on the optical characteristics to be measured. When the absorption of the source beam 38 by the component 28 is to be measured, the transmission PSD 30 detects the intensity of the transmitted beam. When the refraction of the source beam 38 by the component 28 is to be measured, the transmission PSD 30 detects the deviation of the transmitted beam in one or two dimensions. When the local characteristics of the component 28 are to be measured, the transmission PSD 30 detects the shape of the transmitted beam.

FIG. 3, in which like elements share like reference numbers with FIGS. 1 & 2, is a schematic diagram of an optical probe for an optical precision measurement device made in accordance with the present invention. The optical probe 24 includes a laser 66 providing a narrow source beam 38, which passes thorough a beam splitter 54 and a lens 56 to reach the surface 58 of the component 28. In the reflection mode, the surface 58 of the component 28 converts the source beam 38 to a reflected beam 60, which passes through the lens 56 and is reflected by the beam splitter 54 to a reflection position sensitive device (PSD) 62. The surface 58 is sufficiently glossy to reflect the source beam 38 as the reflected beam 60. To reduce false reflections, anti-reflective coatings are typically applied to each optical interface, such as the surfaces of the beam splitter 54, lens 56, and reflection PSD 62.

In the example of FIG. 3, the surface 58 is tilted at a slope angle α from the source beam 38. The reflected beam 60 is reflected at an angle 2α and from the source beam 38. The position where the reflected beam 60 intersects the reflection PSD 62 moves towards the laser 66 the larger the slope angle α. The point on the surface 58 where the source beam 38 contacts the surface 58 and becomes the reflected beam 60 is called a pixel 64. The reflection PSD 62 indicates the deviation of the reflected beam 60 from the path of the source beam 38. The position of the reflected beam 60 on the reflection PSD 62 is a function of the slope of the surface 58 at the pixel 64, the intensity of the reflected beam 60 on the reflection PSD 62 is a function of the reflectivity at the pixel 64, and the shape of the reflected beam 60 on the reflection PSD 62 is a function of the local curvature and cylindricity at the pixel 64.

The reflection PSD 62 is a light sensitive detector capable of detecting the reflected beam and generating a reflected data signal 63 for analysis. Suitable devices include, but are not limited to, analog devices, such as analog lateral-effect photodiodes, and digital devices, such as charge-coupled device (CCD) sensors or complementary metal oxide semiconductor (CMOS) sensors. Typical devices are described in U.S. Pat. No. 5,136,192 to Kooijman, entitled High Speed Measuring Device Utilizing Logarithmic Conversion, and U.S. Pat. No. 5,252,864 to Kooijman, entitled Normalization Circuit For A Measuring Device, both incorporated herein by reference. In one embodiment, the reflection PSD 62 measures the location of the transmitted beam in two directions, so that the slope of the surface 58 can be calculated in two directions. In another embodiment, the reflection PSD 62 includes multiple light sensing elements spaced closely enough to allow determination of shape, directly or by interpolation.

The particular performance requirements of the reflection PSD 62 depend on the measurements to be performed. When the reflectivity of the surface 58 is to be measured, the reflection PSD 62 detects the intensity of the reflected beam 60. When the slope of the surface 58 is to be measured, the reflection PSD 62 detects the deviation of the reflected beam in one or two dimensions. When the local characteristics of the surface 58 are to be measured, the reflection PSD 62 detects the shape of the reflected beam at the reflection PSD 62. Measuring the shape, such as size and ellipticity, allows determination of local characteristics, such as local curvature and cylindricity.

The beam splitter 54 is any device for deflecting the reflected beam, such as a cube splitter, a plate splitter, prism splitter, or a pellicle beam splitter. In one embodiment, the beam splitter 54 is a polarizing beam splitting cube with a ¼ wave plate on the face of the beam splitter 54 nearest the component 28. The ¼ wave plate helps reduce potential occurrence of false reflections, which can shift the centroid of the dot from the resultant beam on the PSD. False reflections can be further limited by particular techniques for particular types of PSDs. False reflections in analog lateral-effect photodiodes, which are used for high-speed applications, are reduced by proper calibration. False reflections in CCD and CMOS sensors are eliminated by software manipulation during analysis. The reduction of false reflections increases measurement accuracy and resolution.

FIG. 4 is a schematic diagram of a position sensitive device (PSD) for an optical precision measurement device made in accordance with the present invention. Examples showing the dot from the resultant beam on the PSD are presented for various component conditions in the reflection mode and transmission mode.

In the reflection mode, the PSD 40 is the reflection PSD and the dot on the PSD 40 is from the reflected beam. Calibration spot 42 is located where a reflected beam intersects the PSD 40 when the surface of the component is normal to the source beam. First deflected dot 44 is deflected from the calibration spot 42 along the first axis, but not along the second axis, indicating the surface is sloping in one direction with respect to the source beam. Second deflected dot 46 is deflected from the calibration spot 42 along both the first and second axes indicating the surface is sloping in two directions with respect to the source beam. The deflection magnitude along one or both axes is measured depending on the analysis to be performed. The intensity of the deflected dot can be measured to determine the reflectivity of the surface. In one example, deflection along the first axis indicates θ-slope, i.e., surface slope of the component perpendicular to the θ-axis and deflection along the second axis indicates φ-slope, i.e., surface slope of the component perpendicular to the φ-axis.

Spread dot 48 is wider and less intense than the first deflected dot 44 or second deflected dot 46 indicating a surface which is less specular and more diffuse. The spread dot 48 is also deflected from the calibration spot 42 indicating surface slope. The amount of deflection can be calculated from the centroid of the spread dot 48 as determined by the PSD 40 directly or by later analysis. Shaped dot 50 displays a non-circular shape indicating local curvature and cylindricity of the surface. The size and ellipticity of the shaped dot 50 can be measured as an indication of the shape, which can be determined by later analysis. As with the spread dot 48, the deflection of the shaped dot 50 can be calculated from the centroid of the shaped dot 50.

In the transmission mode, the PSD 40 is the transmission PSD and the dot on the PSD 40 is from the transmitted beam. The dot characteristics in the transmission mode are similar to those in the reflection mode, except that the change in the source beam is from transmission through the component, rather than reflection by the component. First deflected dot 44 and second deflected dot 46 indicate refraction of the source beam by the component. The intensity of the deflected dots can be measured to indicate the absorption of the source beam by the component and/or reflection loss of the source beam in the component. The intensity variation from dot to dot can be measured to indicate the local characteristics of the component from pixel to pixel. Spread dot 48 indicates refraction and diffusion of the source beam by the component. Shaped dot 50 indicates local characteristics of the component, such as intensity, beam deviation, power asymmetry, or cylindricity in power, and also indicates aberrations, imperfections, or scratches.

In one example, an optical precision measurement device is used to measure a contact lens insert used in manufacturing contact lenses, which typically has a mean radius of curvature of about 8 mm. A source beam having a spot diameter of 35 μm full width at half maximum (FWHM) is focused on or near the surface of the contact lens insert. The lens of the optical probe has a focal length of 25 mm and the reflection PSD has dimensions of 10 mm by 10 mm. This arrangement provides an optical peak-to-peak measuring range of 40° mradian across the reflection PSD, which corresponds to a surface normal tilt range of about 100 mradian in any direction with respect to the source beam.

The surface tilt can be estimated from the equation: displacement=2*surface tilt* lens focal length. The actual surface tilt analysis includes calibration correction, which accounts for actual conditions such as optical probe lens distortion and alignment. A resolution of 10⁻⁴ of the measurement range or better is possible when an analog PSD or a CMOS sensor applying interpolation is used for the reflection PSD. At this resolution, a calibration corrected surface tilt of 20 μradian or better can be measured. This corresponds to 20 nm per mm after integration.

Source beams of different size spot diameters are used for different size components. As discussed above, a source beam having a spot diameter of 35 μm FWHM is used in one example for measuring a contact lens insert. In another example, a source beam having a spot diameter of 300 μm FWHM is used to measure a spectacle lens or spectacle lens insert. In yet another example, a source beam having a spot diameter of 20 μm FWHM is used to measure a mobile phone camera lens.

FIGS. 5 & 6, in which like elements share like reference numbers, are front and side views, respectively, of an alternative embodiment of an optical precision measurement device made in accordance with the present invention. The operation of this alternative embodiment is similar to the operation of the embodiment of FIGS. 1 & 2, but uses a different arrangement for the probe and component stages.

Optical measuring device 70 includes a probe stage 72 supporting optical probe 74 and a component stage 76 supporting component 78. In one embodiment, the optical measuring device 70 includes a transmission position sensitive device (PSD) 80 mounted behind the component 78 from the optical probe 74. The probe stage 72 and the component stage 76 control movement of the optical probe 74 with respect to the component 78. In the reflection mode, the optical probe 74 emits a source beam 88 incident on the component 78 at a pixel, which generates a reflected beam (not shown) back to the optical probe 74 for detection and analysis. In the transmission mode, the source beam 88 incident on the component 78 at a pixel is transmitted and refracted by the component 78, which generates a transmitted beam 71 detected at the transmission position sensitive device 80 for analysis. Testing in the reflection mode and the transmission mode can be performed individually, concurrently, or simultaneously, as desired.

The optical probe 74 uses a narrow beam laser to generate the source beam, and a reflection position sensitive device (PSD) to detect the reflected beam in the reflection mode. The optical probe 74 and its operation are described in relation to FIGS. 3 & 4 above.

Referring to FIGS. 5 & 6, the probe stage 72 and the component stage 76 control the relative motion of the optical probe 74 and the component 78. The probe stage 72 includes a shaft 82, shaft bearings 83, a swing arm 84, and a head 86. The head 86 supports the optical probe 74. The shaft 82 is supported by the shaft bearings 83 and is rotatable about the θ-axis, so the head 86 describes an arc about the component 78 in the x-z plane. In one embodiment, the head 86 further includes an optional radial stage 87 providing movement of the optical probe 74 radially to the θ-axis. The radial stage 87 allows focusing of the source beam 88 on the component 78. In an alternative embodiment, the radial stage 87 is omitted.

The component stage 76 includes a rotating φ-stage 90, an x-stage 92, and a z-stage 94. The φ-stage 90 rotates the component 78 about the φ-axis. The x-stage 92 and the moves the z-stage 94 move the component 78 along the x and z axes, respectively. Those skilled in the art will appreciate that numerous combinations of motion for the probe stage 72 and the component stage 76 can be used to produce the desired relative motion between the optical probe 74 and the component 78.

The probe stage 72 and the component stage 76 include bearings, motors, and position encoders as known to those skilled in the art. The repeatability of stage movement and precision of measurement is typically sufficient to direct the source beam to a pixel or fraction of a pixel with accurate control of slope and tilt as desired for a particular application. Thus, the optical measuring device 70 can measure shapes in the nanometer range without the probe stage 72 and the component stage 76 controlling motion to the nanometer.

The probe stage 72 supports the optical probe 74 at a distance of nanometers to meters from the component 78, depending on the particular component 78 under test. As an example, the probe stage 72 supports the optical probe 74 at a distance of about 20 mm when the component 78 is a contact lens. In an alternative embodiment, the probe stage 72 supports the optical probe 74 at a large distance from the component 78 to permit working of the component 78 with a tool such as a lathe, grinder, or polisher.

FIG. 7 is a front view of another alternative embodiment of an optical precision measurement device made in accordance with the present invention. The operation of this alternative embodiment is similar to the operation of the embodiment of FIGS. 5 & 6, but uses a different arrangement for the component stage.

Optical measuring device 100 includes a probe stage 102 supporting optical probe 104 and a component stage 106 supporting component 108. The probe stage 102 and the component stage 106 control movement of the optical probe 104 with respect to the component 108. In the reflection mode, the optical probe 104 emits a source beam 110 incident on the component 108 at a pixel, which generates a reflected beam (not shown) back to the optical probe 104 for detection and analysis. The optical probe 104 uses a narrow beam laser to generate the source beam, and a reflection position sensitive device (PSD) to detect the reflected beam in the reflection mode. The optical probe 104 and its operation are described in relation to FIGS. 3 & 4 above.

Referring to FIG. 7, the probe stage 102 and the component stage 106 control the relative motion of the optical probe 104 and the component 108. The probe stage 102 includes a swing arm 112 supporting the optical probe 104. The swing arm 112 is rotatable about the θ-axis, so the optical probe 104 describes an arc about the component 108. The component stage 106 includes a shaft 114. The component 108 is mounted on the end of the shaft 114 nearer the optical probe 104. The shaft 114 is rotatable about the φ-axis. In one embodiment, the shaft 114 is moveable along the z-axis to position the component 108 with respect to the optical probe 104. In one embodiment, the φ-axis and the θ-axis have a common intersecting point and their axes are mutually perpendicular. The mean centre of curvature of the surface of the component 108 is located at or near the common intersection point of the θ-axis and the φ-axis. Those skilled in the art will appreciate that numerous combinations of motion for the probe stage 102 and the component stage 106 can be used to produce the desired relative motion between the optical probe 104 and the component 108.

In an alternative embodiment, the component stage 106 is adapted to operation in the transmission mode. The component 108 is mounted in the component stage 106 to provide space for a transmission position sensitive device (PSD) behind the component 108, such as providing a hollow space in the shaft 114 behind the component 108. The source beam 110 passes through the component 108 and is detected as a transmitted beam at the transmission PSD. Testing in the reflection mode and the transmission mode can be performed individually, concurrently, or simultaneously, as desired.

FIG. 8 is a flow diagram for a method of optical precision measurement in accordance with the present invention. The method includes providing an optical probe at a first location relative to the component 120, directing a source beam from the optical probe to a pixel on the component 122, detecting deviation of a resultant beam from the pixel 124, storing the deviation in a component characteristic dataset 126, moving the optical source to other locations relative to the component 128, and repeating the directing, the detecting, and the storing for the other locations 130.

The method operates in a reflection, transmission, or reflection/transmission mode, so that the resultant beam is a reflected beam, a transmitted beam, or both a reflected beam and a transmitted beam, respectively. In the reflection mode, the source beam is reflected from the surface of the component under test. In the transmission mode, the source beam passes through the component. In the reflection/transmission mode, the source beam is both reflected from the surface of the component and passes through the component. Measurements of reflection and transmission are performed simultaneously or sequentially. Deviation is detected between the source beam and the resultant beam or beams.

The reflection mode is able to determine surface topography and surface characteristics for optical components, such as lenses, and opaque components, such as semiconductor components. Deviation is detected between the source beam and the reflected beam.

The transmission mode is able to determine optical characteristics of optical components, such as single lenses or lens systems. The results are similar to those obtained from a computer ray tracing program, only based on actual transmission measurements rather than theoretical component properties and geometries. When the component is a lens or lens system of known design, a computer ray tracing program is used to predict simulated optical characteristics of the component as designed. The actual optical characteristics of the actual component are measured in the transmission mode. Differences between the simulated optical characteristics and the actual optical characteristics are translated into a wave front error plot. Deviation is detected between the source beam and the transmitted beam.

The reflection/transmission mode makes use of both the surface measuring capability of the reflection mode and the optical characteristic measuring capability of the transmission mode. In one example using the reflection/transmission mode, the design data of an unknown lens can be found by first measuring the topography of the front surface in the reflection mode, followed by measuring optical characteristics in the transmission mode.

First, the tilt and decenter of the front surface is determined in the reflection mode. Typically a limited number of measurements are made, rather than measuring the whole front surface. In one embodiment, one ring of data along a first latitude is measured and a second ring of data along a second latitude is measured. The number of data points per ring can be as low as 3 to 4. The tilt and decenter of the front surface is determined from the measurements. In an alternative embodiment, the measurements are made over a selected pattern where the front surface is likely to exhibit tilt and decenter. The selected pattern can be regular, such as a hub and spoke pattern, or can be irregular, which is particularly useful for a free form surface.

Second, a correction for tilt and decenter is applied mechanically by adjusting the positioning of the lens before the transmission mode measurements or is applied virtually in software when analyzing the transmission mode measurements. In one embodiment, the transmission PSD is located at a different z-position or the optical probe scans at a different distance from the lens surface for the measurement in the reflection mode and the transmission mode.

Finally, The transmission mode measurements are performed to determine the optical characteristics of the lens and the design data of an unknown lens determined.

Another example applying the reflection/transmission mode is measurement of decenter between front and back surfaces for replicated or injection molded optics, such as bi-aspheric mobile phone camera lens. Using the reflection mode, the decenter and tilt of the lens with respect to the φ-axis is determined using a scan of the whole front surface. In an alternative embodiment, the scan is performed over a limited portion of the front surface, such as over a limited number of pixels or rings of pixels. The scan can be designed to avoid acquiring data from reflection of the source beam from the back surface of the lens by positioning the optical probe so that the reflection PSD is out of range of the back surface reflections. The correction for tilt and decenter is applied mechanically by adjusting the positioning of the lens or is applied virtually in software when analyzing the transmission mode measurements. Using the transmission mode, the optical characteristics of the lens are determined. The source beam is particularly directed to those portions of the lens where the nominal lens design predicts the largest transmitted beam deflection as a function of decenter of the back surface with respect to the front surface.

In addition to detecting deviation of a resultant beam from the pixel 124, an alternative embodiment includes detecting one or more additional characteristic selected from intensity and shape. The characteristics of the resultant beam as indicated by the dot from the resultant beam on the PSD are presented in conjunction with FIG. 4 above. The detected characteristics of the resultant beam are provided to a data acquisition system, where they are typically stored in digital form as part of the component characteristic dataset. The component characteristic dataset is typically analyzed using a general purpose computer running an analysis program. To determine surface topography, the component characteristic dataset includes at least the surface slope in θ-axis direction for each pixel. For a more comprehensive surface analysis, the component characteristic dataset can also include the surface slope in φ-axis direction and/or the intensity for each pixel.

Referring to FIG. 8, the moving the optical source to other locations relative to the component 128 is performed in one of a number of motion modes, such as a spherical mode, a telecentric mode, and a free form mode.

In the spherical mode, the component rotates about a φ-axis and the optical source rotates about a θ-axis. Typically, the rotation of the component about the φ-axis is at a higher speed than the rotation of the optical source about the θ-axis. The rotation about the θ-axis can be continuous or in steps. The detecting deviation of a resultant beam can also be performed continuously or in steps. In one example, the component rotates continuously about the φ-axis and the characteristics of the resultant beam are sampled every 1° of rotation. The manner of rotation about the θ-axis determines the size and nature of the component characteristic dataset. When the manner of rotation about the θ-axis is step-wise, the component characteristic dataset is a regular grid in a spherical coordinate system as seen on a globe. When the manner of rotation is continuous about the θ-axis, the component characteristic dataset is a spiral. The spiral can be assumed to be the same as the regular grid in a spherical coordinate system, or can be allowed for and transformed into a regular grid in a spherical coordinate system during analysis of the component characteristic dataset. In one example, the rotation about the θ-axis is made at 1° or 0.5° per rotation about the φ-axis, either in a continuous or a step-wise manner. The travel of the optical source about the θ-axis is typically between 0 and 45°, but can be up to a maximum θ angle of 60° or 90°, as desired.

In the telecentric mode, the optical source is maintained at a constant θ angle with respect to the component between 0° and 90°. The optical source is moved in pure translation in the x-axis direction with respect to the component by movement of the probe stage and/or the component stage. The component can also be moved in the z-axis direction and/or be rotated about the φ-axis. The object point is essentially at infinity with either a zero field angle (θ=0) or a finite field angle (θ≠0).

In the free form mode, any relative motion of the optical source and the component is possible, as is desirable for complex component shapes. The relative motion of the optical source and the component is programmed to move along the x-axis and z-axis, and to rotate about the θ-axis and φ-axis, in any combination to achieve the desired motion. For the example of measuring the topography of a torroidal surface in the reflection mode, the relative motion is programmed to keep the source beam normal to the surface and to keep the optical source at a constant distance from the surface to maintain the source beam in focus at the surface. For the example of measuring optical characteristics in the transmission mode, the relative motion is programmed to simulate various wavefronts: spherical convergent or divergent, on- or off-axis, real or virtual, or telecentric. Complex abberated wave fronts can also be simulated.

The component characteristic dataset is analyzed according to the type of measurement performed. For example, when the measurement is run in the reflection mode, analyzing the component characteristic dataset can include determining the topography of the component. In another example, when the measurement is run in the transmission mode, analyzing the component characteristic dataset can include determining the optical characteristics of the component.

During scanning, the characteristics detected for each point are provided from the PSD as data signals to a data acquisition system, where they are typically stored in digital form as the component characteristic dataset for analysis on a general purpose computer running an analysis program. The analysis can be performed real time or offline.

In the reflection mode, the surface topography can be calculated from the surface slope perpendicular to the φ-axis, defined as the θ-slope, or the surface slope perpendicular to the φ-axis (and perpendicular to the θ-slope), defined as the φ-slope. The component characteristic dataset includes the surface slopes, which are the gradients of the surface shape so the surface slopes are integrated to reconstruct the surface topography.

For the example of calculating the surface topography from the θ-slope values, the relative asphericity, i.e., the asphericity compared to sphere of radius R₀, is calculated by integrating around each latitude (φ=constant) as follows:

$$\frac{{R}_{θ}}{{R}_{0}} = exp ( {\int }_{0}^{θ} {S}_{θ} ⅆ θ )$$

where

R₀ is the actual surface profile of the component along the θ integration path, described in polar coordinates with the intersection of the θ-axis and φ-axis as the coordinate center;

R₀ id the reference sphere described in the same coordinate system with the same coordinate center, and coincident with the actual surface profile of the component at the integration starting point, typically at θ=0 and φ=0;

S_{θ} is the θ-slope at the angle increment; and

dθ is the angle increment.

When the component is a perfect sphere, the values of S_{θ} are zero and the ratio of R_{θ}/R₀ is one. Asphericity is defined as the difference between an actual surface and a reference surface. In this case, the asphericity is the difference between R_{θ} and R₀ and the reference surface is the reference sphere. Note that the relative asphericity is a relative value and is independent of the size of the component under test. The absolute asphericity around each latitude (φ=constant) is calculated from:

$$Δ {R}_{θ} = {R}_{θ} - {R}_{0} = {R}_{0} \{ exp ( {\int }_{0}^{θ} {S}_{θ} ⅆ θ ) - 1 \} .$$

The value of R₀ is typically known from the design of the component. When the value of R₀ is unknown, it can be determined by additional measurement. In one embodiment, R₀ is determined by obtaining a second component characteristic dataset with the component at a second z position as is commonly done in interferometry or with wave front sensing, and to calculate R₀ from the two component characteristic datasets. After obtaining the first component characteristic dataset, the component is shifted a known amount along the z-axis. This provides a second and different reference sphere, a new polar coordinate system having a second origin with respect to the component, and a second value of R₀. The difference between the two values of R₀ is known from component shift and the topography of the component is the same in the two component characteristic datasets, so the two values of R₀ can be determined.

In an alternative embodiment, R₀ is determined by measuring a physical parameter from the component, such as the component diameter, and use the measured physical parameter to scale the component characteristic dataset. The absolute asphericity is calculated at each latitude to characterize the surface topography. In one embodiment, the surface topography is calculated for individual portions of the surface and the individual portions stitched together to characterize the whole surface.

The surface topography can be determined in a similar fashion from φ-slope values around each longitude (θ=constant) from:

$$Δ {R}_{φ} = {R}_{φ} - {R}_{0} = {R}_{0} sin θ \{ exp ( {\int }_{0}^{φ} {S}_{φ} ⅆ φ ) - 1 \}$$

where

R_{φ} is the actual surface profile of the component along the φ integration path, described in polar coordinates with the intersection of the θ-axis and φ-axis as the coordinate center;

R₀ is the reference sphere described in the same coordinate system with the same coordinate center, and coincident with the actual surface profile of the component at the integration starting point, typically at θ=0 and φ=0;

S_{φ} is the φ-slope at the angle increment; and

d_{φ} is the angle increment.

To calculate the surface topography from φ-slope values, additional information is needed. In one embodiment, a single R_{θ} scan (φ=constant) can be used to connect the φ-slope values around each longitude (θ=constant).

Those skilled in the art will appreciate that the data in the component characteristic dataset can be used many ways in addition to the examples presented above to reconstruct the component shape and topography. When more data than the θ-slope is collected in the component characteristic dataset, such as slope perpendicular to the φ-axis (φ-slope), intensity, or shape, the surface topography can be confirmed and additional calculations performed. For example, the patent application PCT/IB2003/0062 filed Dec. 24, 2003, by W. Potze, Koninklijke Philips Electronics Reference No. PHNL030022, incorporated herein by reference, discloses an algorithm for making optimal use of redundant slope data for surface integration when a two dimensional PSD is used and both the θ-slope and the φ-slope are collected. The intensity data can be used to identify pixels with slope values caused by dust or scratches. Shape and local curvature can be used to check whether the measured slope values are correct. In other embodiments, the component and component surface can be analyzed in alternative ways, such as power maps or add-on maps as commonly used in the ophthalmics field, or Zernike polynomial coefficient fits as commonly used in the optics field. The component and component surface can be described in spherical, Cartesian, or other convenient coordinate systems.

The topography or other results obtained from analyzing the component characteristic dataset can be used in working the component, such as grinding, polishing, or assembling the component. The optical probe and PSD can be remote from the component, so that they do not interfere with the tool working the component, such as a lathe or polisher. The topography or other results can be compared with the design parameters to generate an error signal for control of the tool. Using the transmission mode, the optical characteristics of multi-element lens systems can be monitored during assembly. Measurements can be made after each lens element is added to the lens system, assuring that the assembly is correct and the lens system performs as designed.

In one embodiment, detecting deviation of a resultant beam from the point 124 includes detecting the deviation with a PSD and calibrating the PSD. Calibrating the PSD includes calibration of any portion of the optical measuring device to provide accurate measurement. To calibrate the PSD for operation in the reflection mode, a calibration method such as wobble calibration, flat mirror calibration, or sphere calibration is used. PSD calibration is performed by adjusting the hardware for offset or alignment, such as physical alignment of the PSD, optical probe, and/or stages, or by adjusting the data in software while analyzing the component characteristic dataset for a particular component under test. The calibration data can be applied to measured data through a linear fit or complex calibration tables.

To perform the wobble calibration method, a flat mirror is provided as the component at a small tilt to the φ-axis. In one embodiment, the flat mirror is made of the same material and has the same optical properties, such as reflectivity and surface roughness, as the component to be tested after calibration. The source beam is directed onto the flat mirror and the mirror is rotated about the φ-axis. The resultant beam describes a cone having a half angle equal to the small angle of the mirror tilt. The resultant beam forms a trace on the PSD. Typically, the trace is nearly circular. The sensitivity in θ-direction and φ-direction is calibrated based on the trace deviation from circularity. The PSD is calibrated by correction of non-circularity in the θ-direction and φ-direction.

Calibration over a greater region of the PSD for the wobble calibration method is obtained by repeating the calibration procedure with different mirror tilts and/or different source beam angles, so that the resultant beam describes different sized traces on the PSD. This provides calibration of the PSD for all possible tilt angles of the component relative to the φ-axis and the θ-axis. The calibration data can also be used to locate the zero of the PSD in the i-direction directly from a fit of the calibration data, such as a mean, circle, or Fourier fit.

The zero of the PSD in the θ-direction can be measured by attaching a temporary jig with a target to the φ-stage as a component. The target is a mark, such as a pinhole, dot, or cross, or a sensor, such as a PSD or camera, used to locate the position of the source beam on the temporary jig. The temporary jig first locates the target a first distance from the optical probe on the φ-axis. The temporary jig is rotated about the φ-axis and the target's position on the φ-stage adjusted until there is no eccentricity in the target's movement about the φ-axis. The temporary jig is moved along the z-axis to a second distance from the optical probe on the φ-axis, and any eccentricity at the second distance zeroed out. The temporary jig is then moved between the first distance and the second distance and adjustments made, until the source beam strikes the center of the target at both the first distance and the second distance as the temporary jig is rotated about the φ-axis.

To perform the flat mirror calibration method, a flat mirror is provided as the component at a small tilt to the φ-axis. In one embodiment, the flat mirror is made of the same material and has the same optical properties, such as reflectivity and surface roughness, as the component to be tested after calibration. The source beam is directed onto the flat mirror and a θ-scan performed, i.e., the optical probe is rotated about the θ-axis while the mirror is stationary relative to the φ-axis. Typically, the mirror is close to the θ-axis, so the source beam stays near a single point on the mirror during the θ-scan. This reduces the sensitivity of calibration to flatness of the mirror. Data is collected from the resultant beam on the PSD for the deflection in the θ-direction and φ-direction. The component is rotated by a calibration angle increment, such as 30° or 60°, about the φ-axis. The θ-scan is repeated and the component is rotated. Additional θ-scans are performed at each calibration angle increment about the φ-axis until the component has been rotated 360°. The sensitivity in the θ-direction can be calibrated from the linearity of the deflection in the θ-direction as a function of φ-axis position. The sensitivity in the φ-direction can be calibrated from the average of the deflection in the φ-direction. The PSD is calibrated by correction of non-linearity in the θ-direction and deviation from the average in the φ-direction.

To perform the sphere calibration method, a sphere is provided as the component. In one embodiment, the sphere a polished metal sphere. In an alternative embodiment, the sphere is made of the same material and has the same optical properties, such as reflectivity and surface roughness, as the component to be tested after calibration. The source beam is directed onto the sphere at zero degrees along the θ-axis and the φ-axis. Data is collected from the resultant beam on the PSD for deflection in the θ-direction and φ-direction. The source beam is moved in the θ-direction by a small longitudinal increment, such as 0.5° or 1°. A ring of data is collected by rotating the sphere in the φ-direction and collecting data at small latitudinal increments, such as 1° or 2°. The procedure is repeated until rings of data have been collected over the desired portion of the sphere, such as from 0 values between about 0° and 45°, or 0° and 90° or greater. Because the component is a sphere, the deflection in the θ-direction and φ-direction should be zero, i.e., the surface slope should be zero, and there should be no asphericity. The sphere surface is reconstructed from the rings of data and compared to the expected sphere surface for the polished metal sphere. The PSD is calibrated by physical correction of any misalignment, such as correcting the PSD, optical probe, and/or stage alignment, or by adjusting the data in software while analyzing the component characteristic dataset for a particular component under test.

FIG. 9 is a block diagram for machine control incorporating a method of optical precision measurement in accordance with the present invention. The optical measurement device 200 sends a source beam 202 to a pixel of the surface 204, which returns a resultant beam 206. The optical measurement device 200 is typically remote from the surface 204 to avoid interference with the tool 208. The resultant beam 206 can be a reflected beam or transmitted beam, depending on the desired application. The surface 204 is worked by the tool 208, such as by machining on a lathe, by polishing, or by grinding. The surface 204 is measured by the optical measurement device 200 while the surface 204 is being worked by the tool 208. The surface 204 can also be measured by the optical measurement device 200 with the tool 208 stopped, but while the surface 204 remains mounted in the working machine, i.e., the lathe, polisher, or grinder. For tools using water jets or abrasives, the optical measurement device can be protected behind a window which opens when the surface measurement is made.

The optical measurement device 200 generates a measurement signal 210 characteristic of the surface 204 from the resultant beam 206. The measurement signal 210 is compared to a design signal 212 from design storage 214 at a comparator 216. The desired design for the surface 204 stored in the design storage 214 can be a preset design or an interactive design which changes with the actual progress of the working of the surface 204. The comparator 216 generates a difference signal 218 from the comparison of the measurement signal 210 and the design signal 212. The machine control 220 receives the difference signal 218 and generates a control signal 222, which controls the tool 208 working the surface 204.

FIG. 10 is a perspective view of a lathe including an optical precision measurement device made in accordance with the present invention. The same components which control motion of the tool to work the surface also control the motion of the optical probe of the optical measurement device. The action of the optical precision measurement is like that described for FIGS. 1 & 2.

Referring to FIG. 10, the lathe 230 includes a bed 232 supporting a lathe carriage 234, which in turn supports a tool holder 236. Cutting tools 238 are held by the tool holder 236. A turning head 240 retains and rotates component 242 about the φ-axis so the component 242 can be worked on the lathe 230 with the cutting tools 238. The lathe carriage 234 moves on the bed 232 along the z-axis and the tool holder 236 moves on the lathe carriage 234 along the x-axis. The motion of the cutting tools 238 relative to the component 242 permits precise machining of the component 242.

To provide optical precision measurement, a θ-stage 244 is operably connected to the tool holder 236 and an optical probe 246 attached to the θ-stage 244. The optical probe 246 directs a source beam 248 to the component 242. In this example, the optical probe 246 detects a resultant beam (not shown), which is a reflected beam for determining the surface topography of the component 242. The lathe carriage 234, tool holder 236, and θ-stage 244 act as a probe stage, controlling motion of the optical probe 246 in the x and z directions and about the θ-axis. The turning head 240 acts as a component stage, controlling motion of the component 242 about the φ-axis. The motion for measurement is controlled by the same controller used to control working of the component 242.

The optical precision measurement is coordinated with the working of the component 242. In one embodiment, the optical precision measurement is performed simultaneously with the working of the component 242. In an alternative embodiment, the optical precision measurement is performed when the component 242 is not being worked, with the component 242 rotating or stationary depending on the measurement desired. Those skilled in the art will appreciate that the optical precision measurement arrangement described for the lathe is applicable to a number of other machines, such as polishers and grinders.

FIGS. 11 & 12, in which like elements share like reference numbers with FIGS. 5 & 6, are a perspective and cross section view, respectively, of alternative embodiments of supports for a probe stage of an optical precision measurement device made in accordance with the present invention. The supports provide additional degrees of freedom and a greater range of motion for existing degrees of freedom.

Referring to FIG. 11 for one alternative support for the probe stage, a Cardanic ring 150, also known as a gimbal ring, supports a swing arm 84. The Cardanic ring 150 includes an inner ring 152, an outer ring 154, first shafts 82, and second shafts 156. The first shafts 82 support the inner ring 152 on the outer ring 154, and provide rotation of the inner ring 152 about the θ-axis. The second shafts 156 support the outer ring 154 and provide rotation of the outer ring 154 about the Ψ-axis. The θ-axis and the Ψ-axis are typically perpendicular to each other. The swing arm 84 is attached to the inner ring 152. The optical probe (not shown) is supported by the swing arm 84 connected to the inner ring 152 and rotates about the θ-axis with the inner ring 152. The component stage 76 is located within the inner ring 152. In one embodiment, the component stage 76 moves the component 78 in the x, y, and z directions and provides rotation about the φ-axis. The Cardanic ring 150 includes bearings, motors, and position encoders for driving and monitoring (not shown) as are known to those skilled in the art.

Referring to FIG. 12 for another alternative support for the probe stage, a gliding stage 170 supports shaft bearings 83, which rotatably support shaft 82. The shaft 82 is rotatable about the θ-axis. The swing arm 84 attached to the shaft 82 supports the optical probe (not shown) for directing a source beam to the component 78 mounted on the component stage 76. The gliding stage 170 includes a first bearing ring 172 and a second bearing ring 174. The complementary surfaces 176, 178 of the first bearing ring 172 and second bearing ring 174 are shaped so that the first bearing ring 172 can rotate about a point 180 centered on and above the gliding stage 170. In one embodiment, the point 180 is at or near the focusing point of the optical probe. Those skilled in the art will appreciate that in an alternative embodiment the slope of the complementary surfaces 176, 178 is reversed from toward the center of the gliding stage 170 as illustrated to toward the outside of the gliding stage 170, so that the point 180 is below the gliding stage 170. The gliding stage 170 includes bearings, motors, and position encoders for driving and monitoring (not shown) as are known to those skilled in the art.

The optical measuring device can also provide motion in the y-direction between the optical probe and the component. In one embodiment, the gliding stage 170 is supported on a y-stage 182 providing motion of the optical probe in the y-direction. In an alternative embodiment, the component stage 76 provides motion of the component in the y-direction. The y-stage 182 includes bearings, motors, and position encoders for driving and monitoring (not shown) as are known to those skilled in the art.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. A method of optical precision measurement of a component comprising:
providing an optical probe at a first location relative to the component 120;
directing a source beam from the optical probe to a pixel on the component 122;
detecting deviation of a resultant beam from the pixel 124;
storing the deviation in a component characteristic dataset 126;
moving the optical source to other locations relative to the component 128; and
repeating the directing, the detecting, and the storing for the other locations 130.

2. The method of claim 1 wherein the resultant beam is selected from the group consisting of a reflected beam 60, a transmitted beam 21, and both a reflected beam 60 and a transmitted beam 21.

3. The method of claim 1 further comprising detecting an additional characteristic of the resultant beam, the additional characteristic selected from the group consisting of intensity and shape.

4. The method of claim 1 wherein the moving the optical source to other locations relative to the component 128 comprises rotating the component about a φ-axis.

5. The method of claim 3 wherein the moving the optical source to other locations relative to the component 128 additionally comprises moving the optical source about a θ-axis.

6. The method of claim 1 wherein the moving the optical source to other locations relative to the component 128 comprises moving the optical source relative to the component in a mode selected from the group consisting of a spherical mode, a telecentric mode, and a free form mode.

7. The method of claim 1 further comprising analyzing the component characteristic dataset.

8. The method of claim 6 wherein the resultant beam is a reflected beam from a surface of the component and the analyzing the component characteristic dataset comprises analyzing the surface for a property selected from the group consisting topographic properties, power maps, add-on maps, and Zernike polynomial coefficient fits.

9. The method of claim 6 wherein the resultant beam is a transmitted beam and the analyzing the component characteristic dataset comprises determining optical characteristics of the component.

10. The method of claim 6 further comprising working the component in response to results from the analyzing the component characteristic dataset.

11. The method of claim 1 wherein the detecting deviation of a resultant beam from the pixel 124 comprises detecting deviation of a resultant beam from the pixel 124 with a position sensitive detector (PSD), and further comprising calibrating the PSD.

12. The method of claim 10 wherein the calibrating the PSD comprises:
providing a flat mirror at a tilt to a φ-axis;
directing the source beam onto the flat mirror;
rotating the flat mirror about the φ-axis;
detecting a trace on the PSD; and
determining sensitivity of the PSD from the trace.

13. The method of claim 10 wherein the calibrating the PSD comprises calibrating the PSD by a method selected from the group consisting of wobble calibration, flat mirror calibration, and sphere calibration.

14. A system for optical precision measurement of a component comprising:
an optical probe 24 at a first location relative to the component 28;
means for directing a source beam from the optical probe to a pixel on the component 22;
means for detecting deviation of a resultant beam from the pixel 30;
means for storing the deviation in a component characteristic dataset;
means for moving the optical source to other locations relative to the component 26; and
means for repeating the directing, the detecting, and the storing for the other locations.

15. The system of claim 13 further comprising means for analyzing the component characteristic dataset.

16. The system of claim 13 further comprising means for calibrating the detecting means.

17. A device for optically measuring a component, comprising:
an optical probe 24, the optical probe 24 providing a source beam 38;
a probe stage 22, the probe stage 22 being operable to rotate the optical probe 24 about a θ-axis;
a component stage 26, the component stage 26 being operable to rotate the component 28 about a φ-axis; and
a position sensitive detector;
wherein the probe stage 22 directs the source beam 38 to the component 28, the source beam 38 generates a resultant beam from the component 28, and the position sensitive detector detects the resultant beam.

18. The device of claim 16 wherein relative motion of the probe stage 22 and the component stage 26 is operable to move the optical probe 24 relative to the component 28 along an x-axis and a z-axis.

19. The device of claim 16 wherein the resultant beam is selected from the group consisting of a reflected beam 60, a transmitted beam 21, and both a reflected beam 60 and a transmitted beam 21.

20. The device of claim 16 wherein the position sensitive detector is selected from the group consisting of analog lateral-effect photodiodes, charge-coupled device (CCD) sensors, and complementary metal oxide semiconductor (CMOS) sensors.
